(19) United States
(12) Patent Application Publication
(10) Pub. No.: US 2015/0155101 A1
(43) Pub. Date: Jun. 4, 2015

(54) Forming Method of Solid Electrolytic Capacitor

(71) Applicants: NEC TOKIN CORPORATION, Miyagi (JP); Kemet Electronics Corporation, Simpsonville, SC (US)

(72) Inventors: Kenji Araki, Miyagi (JP); Takashi Kono, Miyagi (JP); Takashi Mihara, Miyagi (JP); Yoshihiko Saiki, Tokyo (JP)

(73) Assignees: NEC Tokin Corporation; Kemet Electronics Corporation

(21) Appl. No.: 14/559,147

(22) Filed: Dec. 3, 2014

(30) Foreign Application Priority Data
Dec. 4, 2013 (JP) 2013-250970

(51) Int. Cl. H01G 9/00; H01G 9/04; H01G 9/15

(52) U.S. Cl. CPC H01G 9/0029; H01G 9/15; H01G 9/04; H01G 9/0032; H01G 9/0036; H01G 2009/0014

(57) ABSTRACT

A method of forming a solid electrolytic capacitor includes forming an intermediate. The intermediate includes a capacitor element which includes an anode body, a dielectric layer formed on the anode body, a cathode layer formed on the dielectric layer and an anode lead wire extending from the anode body. The method further includes forming a plated layer on the cathode layer by soaking the intermediate into a plating solution to apply a voltage between the plating solution and the anode lead wire so that an electric potential of the plating solution is higher than another electric potential of the anode lead wire.

### CROSS REFERENCE TO RELATED APPLICATIONS

Applicants claim priority under 35 U.S.C. §119 of Japanese Patent Application No. JP2013-250970 filed Dec. 4, 2013.

### BACKGROUND OF THE INVENTION

This invention relates to a method of forming a solid electrolytic capacitor which has a plated layer formed on a cathode layer.

JP S59-219924 A, which is incorporated herein by reference, discloses a method of forming a solid electrolytic capacitor which includes forming a plated layer on a cathode layer via electroless plating. There is a need for a method of forming a plated layer on a cathode layer via electroplating, in view of cost and time on formation of solid electrolytic capacitor.

### SUMMARY OF THE INVENTION

It is therefore an object of the present invention to provide a method of forming a solid electrolytic capacitor that has a plated layer formed on a cathode layer via electroplating.

One aspect of the present invention provides a method of forming a solid electrolytic capacitor which includes forming an intermediate. The intermediate comprises a capacitor element which includes an anode body, a dielectric layer formed on the anode body, a cathode layer formed on the dielectric layer and an anode lead wire extending from the anode body. The method further includes forming a plated layer on the cathode layer by soaking the intermediate into a plating solution to apply a voltage between the plating solution and the anode lead wire so that an electric potential of the plating solution is higher than another electric potential of the anode lead wire.

Another aspect of the present invention provides the aforementioned method of forming a solid electrolytic capacitor, wherein: the intermediate further comprises a conductive connection section which connects the cathode lead wire with the anode lead wire; and the method further comprises removing the conductive connection section to electrically separate the cathode layer and the anode lead wire.

Since the anode lead wire is used as one of electrodes of the electroplating, one aspect of the present invention can make the formation of the solid electrolytic capacitor simple.

Especially, if the plated layer is formed after the anode lead wire and the cathode layer is connected with each other by using a conductor, no potential difference occurs between an anode body and the cathode layer which sandwich the dielectric layer so that electrical currents do not flow into the dielectric layer.

An appreciation of the objectives of the present invention and a more complete understanding of its structure may be had by studying the following description of the preferred embodiment and by referring to the accompanying drawings.

### BRIEF DESCRIPTION OF THE DRAWINGS

FIG. 1 is a cross-sectional view showing a solid electrolytic capacitor according to a first embodiment of the present invention.

FIG. 2 is a cross-sectional view showing a capacitor element and a plated layer which are included in the solid electrolytic capacitor of FIG. 1.

FIG. 3 is a view showing a process of formation of the capacitor element of FIG. 2.

FIG. 4 is a view showing another process of the formation of the capacitor element of FIG. 2.

FIG. 5 is a view showing another process of the formation of the capacitor element of FIG. 2.

FIG. 6 is a view showing a process of formation of the plated layer of FIG. 2.

FIG. 7 is a view showing a process of formation of the capacitor element and the plated layer of FIG. 2.

FIG. 8 is a cross-sectional view showing a capacitor element and a plated layer which are included in a solid electrolytic capacitor according to a second embodiment of the present invention.

FIG. 9 is a view showing a process of formation of the capacitor element of FIG. 8.

FIG. 10 is a view showing a process of formation of the plated layer of FIG. 8.

FIG. 11 is a cross-sectional view showing a capacitor element and a plated layer which are included in a solid electrolytic capacitor according to a third embodiment of the present invention.

FIG. 12 is a view showing a process of formation of the capacitor element of FIG. 11.

FIG. 13 is a view showing a process of formation of the capacitor element of FIG. 11.

FIG. 14 is a view showing a process of formation of the plated layer of FIG. 11.

FIG. 15 is a cross-sectional view showing a capacitor element and a plated layer which are included in a solid electrolytic capacitor according to a fourth embodiment of the present invention.

FIG. 16 is a view showing a process of formation of the plated layer of FIG. 15.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DESCRIPTION OF PREFERRED EMBODIMENTS

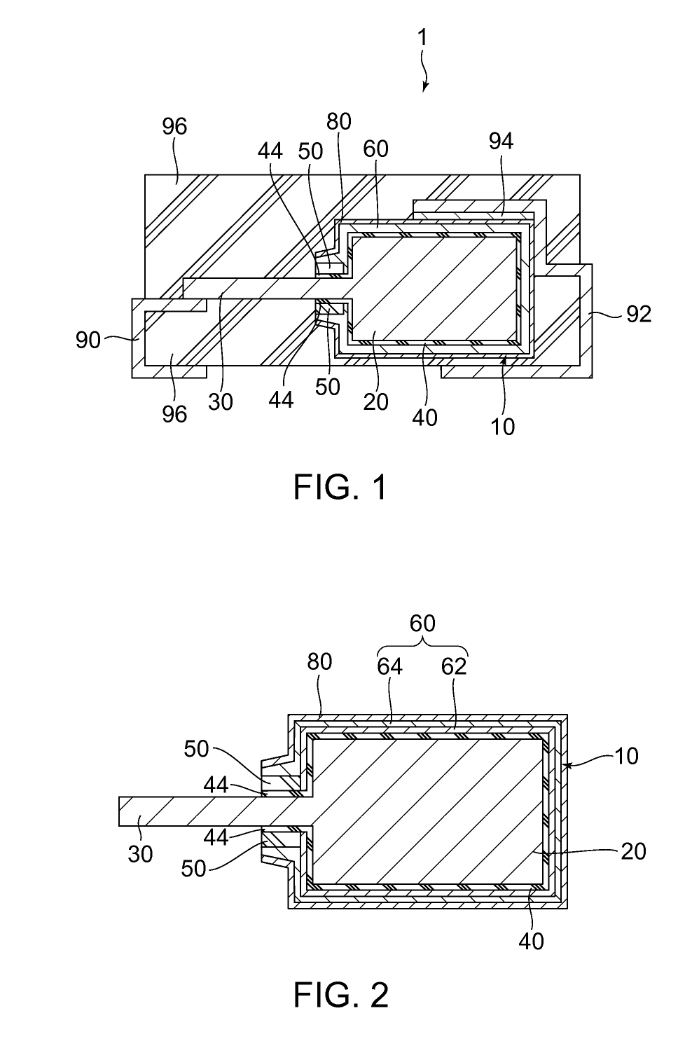

With reference to FIG. 1, a solid electrolytic capacitor 1 according to a first embodiment of the present invention comprises a capacitor element 10, a plated layer 80, an anode terminal 90, a cathode terminal 92 and an outer insulation member 96. As shown in FIG. 2, the capacitor element 10 comprises an anode body 20, an anode lead wire 30, a dielectric layer 40, an additional dielectric layer 44, an insulative section 50 and a cathode layer 60. The illustrated cathode layer 60 includes a solid electrolyte layer 62 and a conductive layer 64.

The anode body 20 of the present embodiment is formed of sintered tantalum powder. The anode lead wire 30 is a tantalum wire and is partially embedded in the anode body 20. The anode lead wire 30 extends along a predetermined direction, i.e. a lateral direction in FIG. 2. The dielectric layer 40 is formed on the anode body 20 while the additional dielectric layer 44 is formed on the anode lead wire 30. Although the dielectric layer 40 and the additional dielectric layer 44 are conceptually distinct from each other for the sake of better understanding, the dielectric layer 40 and the additional dielectric layer 44 are formed integrally with each other upon a common process.

The solid electrolyte layer 62 of the cathode layer 60 is formed on the dielectric layer 40. The solid electrolyte layer 62 of the present embodiment is made of polythiophene. Namely, the solid electrolyte layer 62 of the present embodiment is made of conductive polymer. The solid electrolyte layer 62 may be made of another conductive polymer or may be made of manganese dioxide. The insulative section 50 is formed on the additional dielectric layer 44. More specifically, the insulative section 50 is positioned around a root of the anode lead wire 30. The insulative section 50 of the present embodiment is made of epoxy resin. However, the insulative section 50 may be made of another insulative member. The insulative section 50 may not be provided. The conductive layer 64 of the present embodiment is a conductive coating layer which is formed by graphite paste. Namely, the conductive layer 64 of the present embodiment is made of conductive paste. The conductive layer 64 may be made of another conductive material. The illustrated conductive layer 64 covers the solid electrolyte layer 62 and is also formed on the insulative section 50.

The plated layer 80 of the present embodiment covers almost all the capacitor element 10. Specifically, the plated layer 80 of the present embodiment is formed all over the cathode layer 60.

Each of the anode terminal 90 and the cathode terminal 92 is made of a base member of 42 alloy plated with solder. However, each of the anode terminal 90 and the cathode terminal 92 may be made of another metal. The anode lead wire 30 is welded to the anode terminal 90 through resistance welding. On the other hand, the cathode terminal 92 is bonded to the cathode layer 60 by using a conductive resin 94. The conductive resin 94 of the present embodiment is made of silver paste. Instead of the conductive resin 94, another conductive adhesive agent may be used. Furthermore, the anode lead wire 30 and the anode terminal 90 may be connected with each other via other connection means. Likewise, the cathode layer 60 and the cathode terminal 92 may be connected with each other via other connection means.

The outer insulation member 96 of the present embodiment is made of epoxy resin. However, the outer insulation member 96 may be made of another insulative member. The outer insulation member 96 encloses a part of the anode terminal 90 and a part of the cathode terminal 92 and seals the whole capacitor element 10 off.

Since the plated layer 80 of the present embodiment covers the whole cathode layer 60 as described above, it is hard for oxygen or moisture to reach the solid electrolyte layer 62. Therefore, the present embodiment can reduce degradation of the solid electrolyte layer 62.

In addition, the insulative section 50 makes a large distance between the anode lead wire 30 and the cathode layer 60a so that the insulative section 50 can prevent them from being short-circuited with each other.

Hereinafter, a formation method of the solid electrolytic capacitor 1 of the present embodiment is explained in detail.

First, the anode lead wire 30 of the tantalum wire is partially embedded in tantalum powder, and the tantalum power is then press-molded so that a molded member is obtained. Next, the molded member is sintered so that the anode body 20 of the sintered tantalum power is formed. Thereafter, the anode body 20 and the anode lead wire 30 are soaked into an aqueous solution of phosphoric acid to be anodized so that the dielectric layer 40 and the additional dielectric layer 44 each made of an anodic oxide film are formed. Specifically, the dielectric layer 40 of the anodic oxide film is formed on the surface of the anode body 20 while the additional dielectric layer 44 of the anodic oxide film is formed on the surface of the anode lead wire 30. The anodization may use another solution.

Next, the solid electrolyte layer 62 is formed on the dielectric layer 40 by alternately soaking the dielectric layer 40 into a liquid of thiophene and an oxidizer so that a chemical polymerization is repeatedly carried out. The oxidizer is a methanol solution containing 30% ferric paratoluenesulfonate. The oxidizer may be made of another solution. The solid electrolyte layer 62 of polythiophene is formed by alternately repeating an impregnation process by using conductive polymer slurry and a drying process.

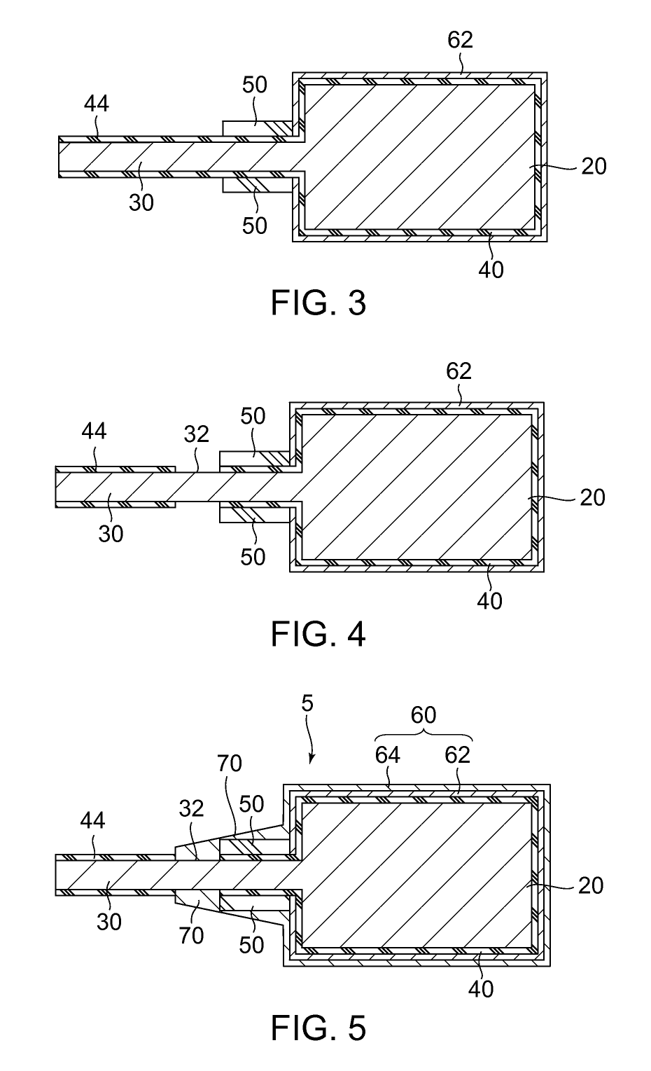

After the formation of the solid electrolyte layer 62, the insulative section 50 is formed as shown in FIG. 3. However, the present invention is not limited thereto. The insulative section 50 may not be formed.

Subsequently, as show in FIG. 4, the additional dielectric layer 44 is partially removed with a laser so that a part of the anode lead wire 30 is exposed as an exposed portion 32. Next, as shown in FIG. 5, the graphite paste (conductive paste) is applied or put from the solid electrolyte layer 62 to the exposed portion 32 of the anode lead wire 30 so that the conductive layer 64 of the cathode layer 60 is formed while a conductive connection section 70 is formed to connect the conductive layer 64 of the cathode layer 60 and the exposed portion 32 of the anode lead wire 30 with each other. Thus, the conductive layer 64 and the conductive connection section 70 of the present embodiment are made of hardened conductive paste. The conductive layer 64 and the conductive connection section 70 may be made of other conductive materials. The conductive connection section 70 connects the anode lead wire 30 and the cathode layer 60 with each other. Thus, an intermediate 5 including the capacitor element 10 and the conductive connection section 70 is obtained.

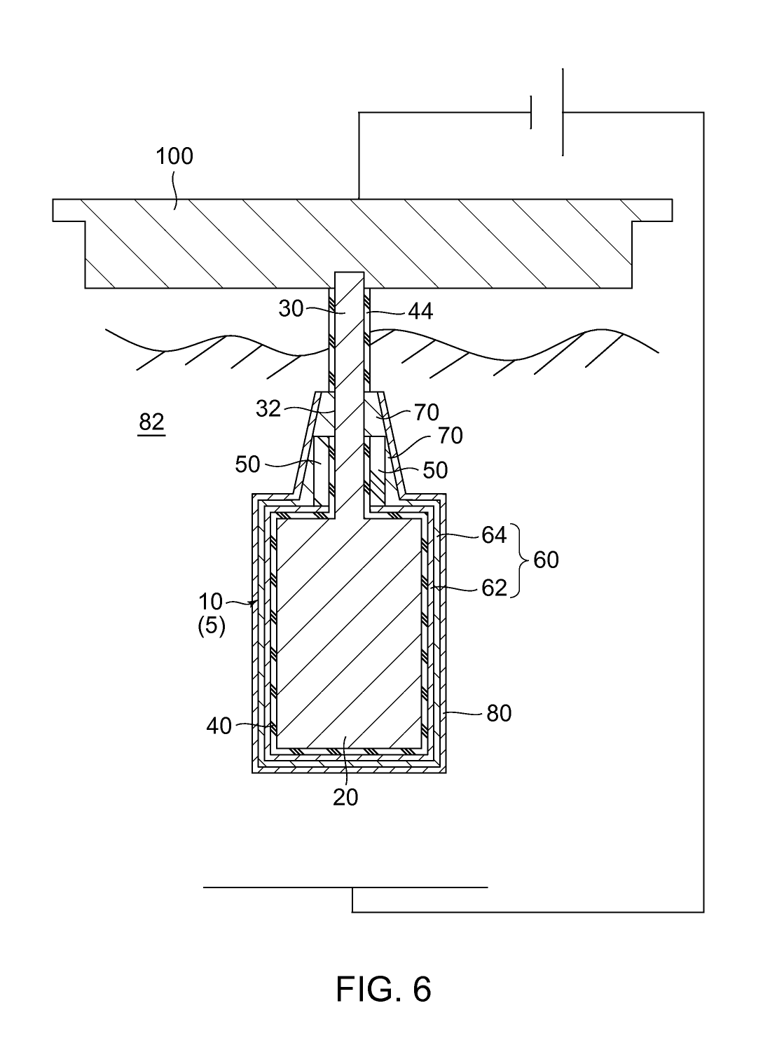

After the formation of the intermediate 5, as shown in FIG. 6, the intermediate 5 is soaked into a plating solution 82 while an end of the anode lead wire 30 is supported by the supporter 100 made of aluminum. In addition, a voltage is applied between the plating solution 82 and the supporter 100 so that an electric potential of the plating solution 82 is higher than another electric potential of the supporter 100, i.e. an electric potential of the anode lead wire 30 or an electric potential of the cathode layer 60. The plating solution 82 of the present embodiment is an aqueous solution of copper sulfate. However, the plating solution 82 may be made of another solution. Thus, the plated layer 80 is formed. The plated layer 80 of the present embodiment is a plated copper layer. The plated layer 80 may be made of another metal.

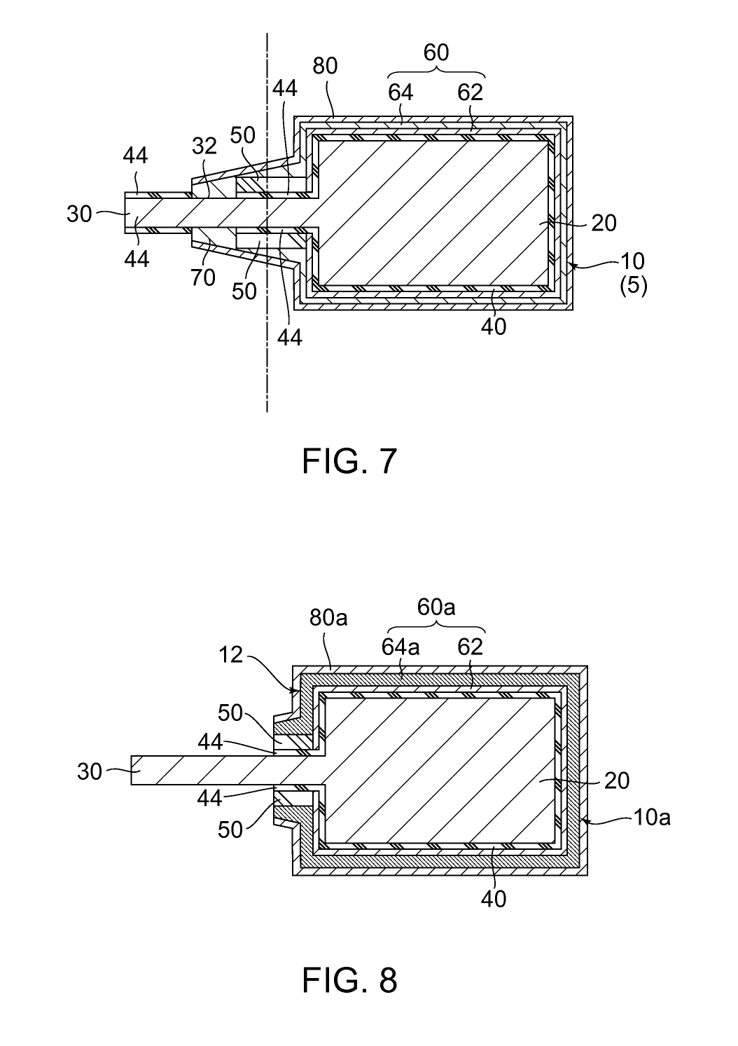

Subsequently, as understood from FIGS. 2 and 7, the conductive connection section 70 is removed with a laser so that the cathode layer 60 and the anode lead wire 30 are electrically separated. At the same time, the plated layer 80, the insulative section 50 and the additional dielectric layer 44 are also partially removed. Thus, the capacitor element 10 covered with the plated layer 80 is obtained.

Thereafter, the anode terminal 90 and the cathode terminal 92 are connected to the anode lead wire 30 and the cathode layer 60, respectively. Next, the outer insulation member 96 is formed by carrying out injection molding with a metal mold of a predetermined shape, followed by hardening it. After the formation of the outer insulation member 96, each of the anode terminal 90 and the cathode terminal 92 is folded to the bottom of the outer insulation member 96 to have an angular C-shape. Thus, the solid electrolytic capacitor 1 is obtained.

A solid electrolytic capacitor according to a second embodiment of the present invention is different from the solid electrolytic capacitor according to the aforementioned first embodiment in structure of the capacitor element; they are same as each other in components other than the capacitor element such as the anode terminal and the cathode terminal.

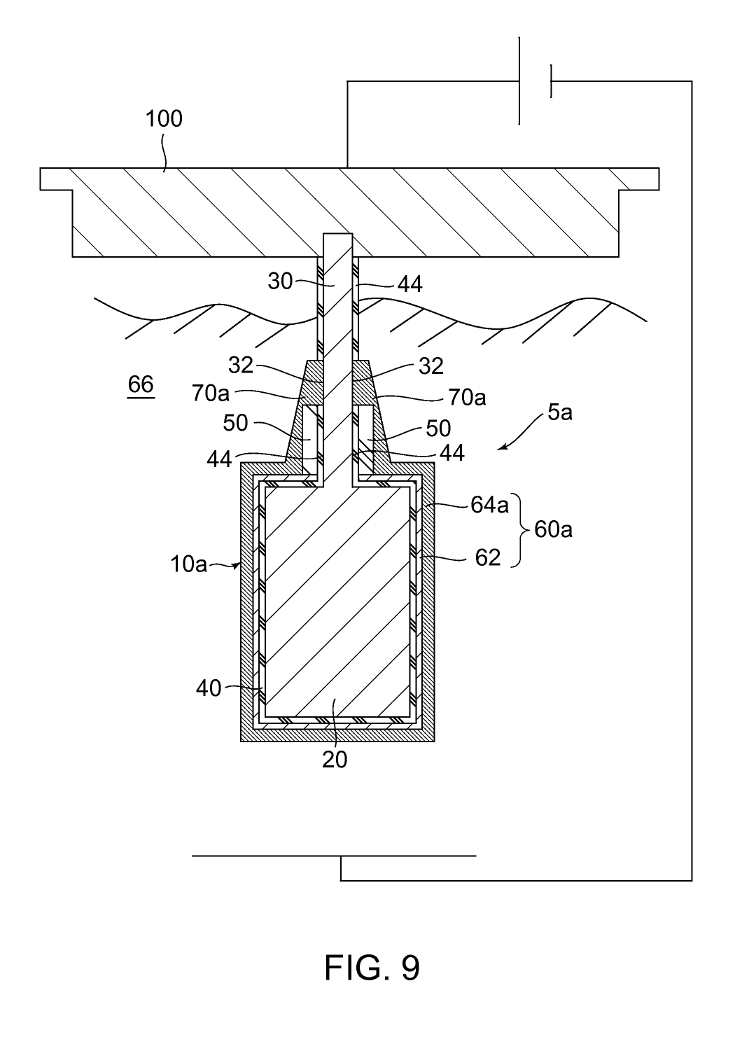

With reference to FIG. 8, a capacitor element 10a according to the present embodiment is a modification of the capacitor element 10 of the above-mentioned first embodiment. In FIG. 8, components same as those of FIG. 2 are depicted with reference numerals same as those of the same components; explanation about those components will be omitted.

As shown in FIG. 8, a cathode layer 60a of the present embodiment includes the solid electrolyte layer 62 and a conductive layer 64a.

The conductive layer 64a of the present embodiment is an electrolytic polymerization layer which is formed after the formation of the insulative section 50. The illustrated conductive layer 64a covers the solid electrolyte layer 62 and is also formed on the insulative section 50. As shown in FIG. 9, after the formation of the insulative section 50 and the exposed portion 32, the electrolyte layer 62 and the exposed portion 32 are soaked into a solution of monomers 66 while an end of the anode lead wire 30 is supported by the supporter 100 made of aluminum. The solution of monomers 66 of the present embodiment is an aqueous solution containing 5% pyrrole. In addition, a voltage is applied between the solution of monomers 66 and the supporter 100 so that an electric potential of the solution of monomers 66 is lower than another electric potential of the supporter 100, i.e. an electric potential of the anode lead wire 30 or an electric potential of the solid electrolyte layer 62. Thus, electrolytic polymerization is carried out by using the exposed portion 32 as a starting point thereof, so that the conductive layer 64a and a conductive connection section 70a are formed. Thus, an intermediate 5a including the capacitor element 10a and the conductive connection section 70a is obtained. The conductive layer 64a and the conductive connection section 70a of the present embodiment are made of polypyrrole. The solution of monomers 66 may be another solution of monomers, and the conductive layer 64a and the conductive connection section 70a may be made of another conductive polymer. The conductive layer 64a and the conductive connection section 70a may be formed via chemical polymerization.

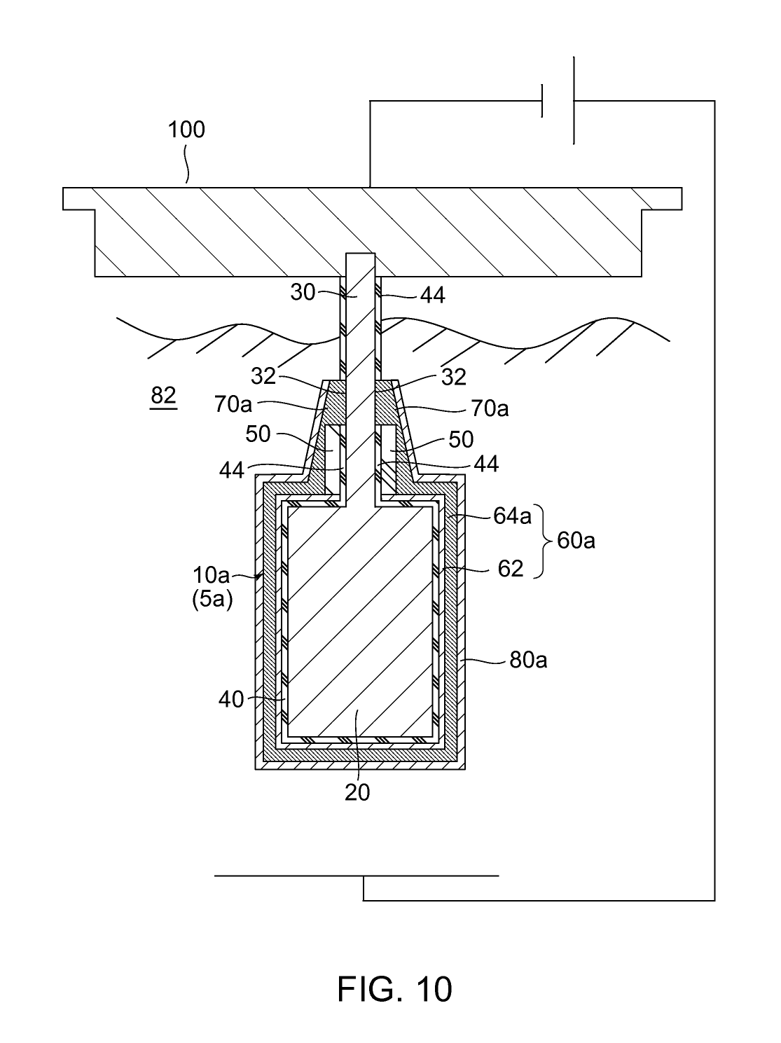

After the formation of the conductive layer 64a and the conductive connection section 70a, a plated layer 80a is formed by using the conductive connection section 70a. In detail, as shown in FIG. 10, the intermediate 5a is soaked into the plating solution 82. In addition, a voltage is applied between the plating solution 82 and the supporter 100 so that an electric potential of the plating solution 82 is higher than another electric potential of the supporter 100, i.e. an electric potential of the anode lead wire 30 or an electric potential of the cathode layer 60a. Subsequently, the conductive connection section 70a is removed with a laser so that the cathode layer 60a and the anode lead wire 30 are electrically separated. At the same time, the plated layer 80a, the insulative section 50 and the additional dielectric layer 44 are also partially removed. Thus, the capacitor element 10a covered with the plated layer 80a is obtained.

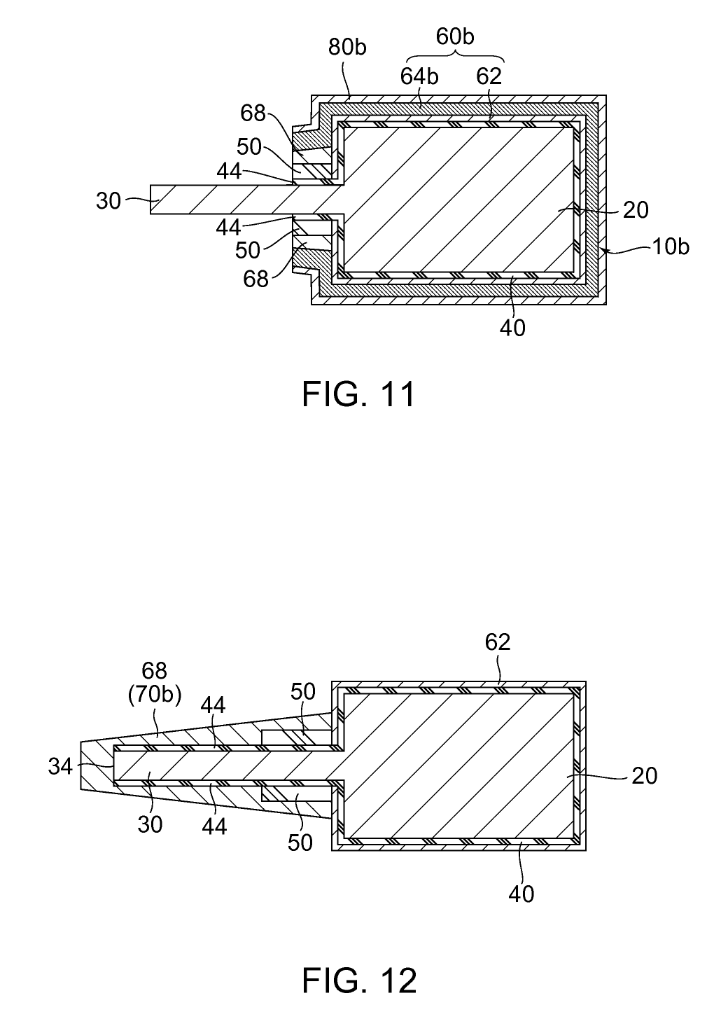

With reference to FIG. 11, a capacitor element 10b according to a third embodiment of the present invention is a modification of the capacitor element 10a of the above-mentioned second embodiment. In FIG. 11, components same as those of FIG. 8 are depicted with reference numerals same as those of the same components; explanation about those components will be omitted.

As shown in FIG. 11, a cathode layer 60b of the present embodiment includes the solid electrolyte layer 62, the conductive layer 64b and a conductive section 68.

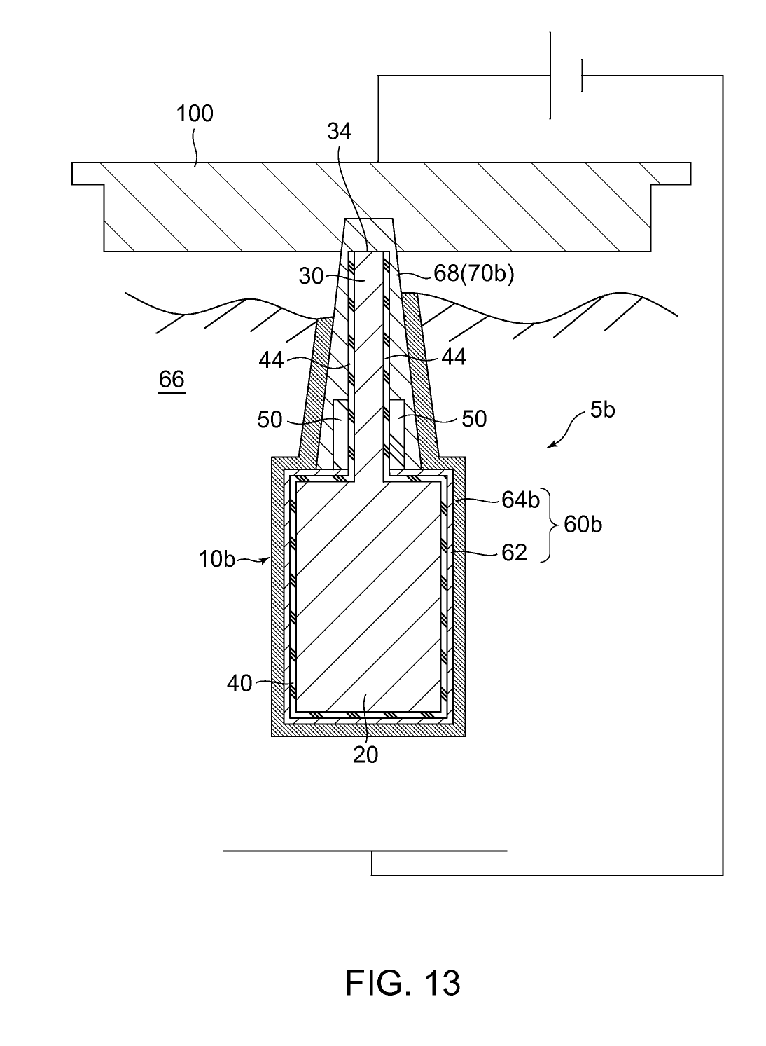

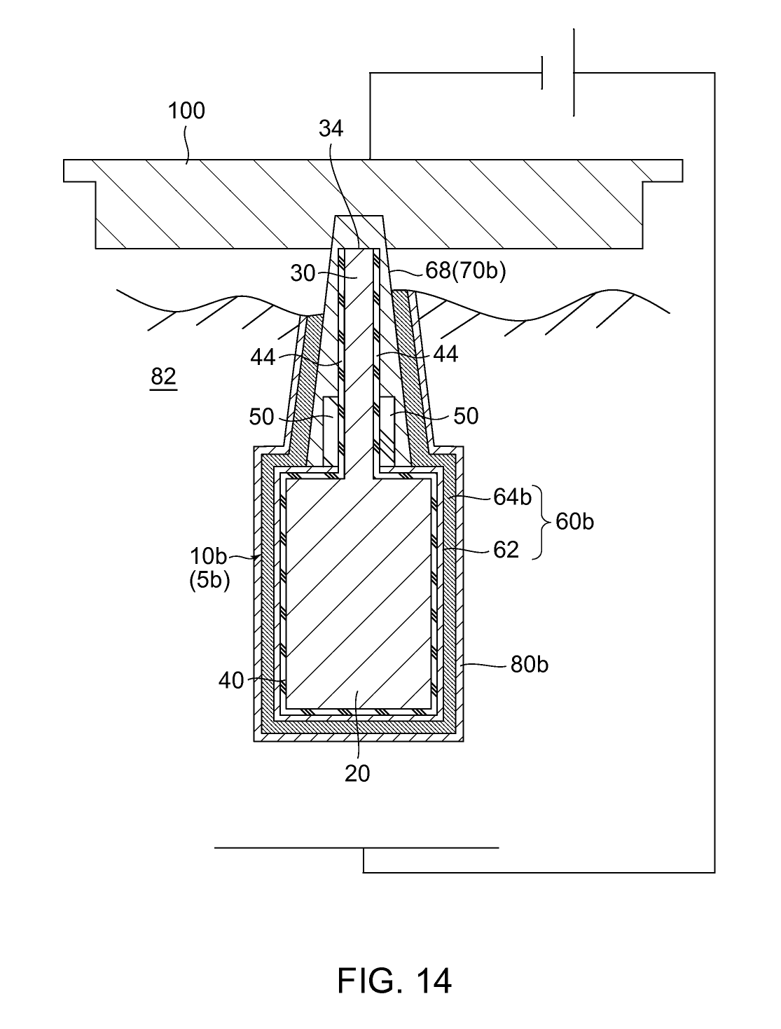

The conductive section 68 is formed on the insulative section 50. The conductive section 68 of the present embodiment is a rest of a conductive connection section 70b which is used for the formation of the conductive layer 64b of the electrolytic polymerization layer and for the formation of the plated layer 80b. As shown in FIG. 12, after the formation of the insulative section 50, the conductive connection section 70b is formed so as to connect between an end 34 of the anode lead wire 30 and the solid electrolyte layer 62. Next, as shown in FIG. 13, the electrolyte layer 62 and a part of the conductive connection section 70b are soaked into a solution of monomers 66 while an end of the conductive connection section 70b is supported by the supporter 100 made of aluminum. In addition, a voltage is applied between the solution of monomers 66 and the supporter 100 so that an electric potential of the solution of monomers 66 is lower than another electric potential of the supporter 100, i.e. an electric potential of the conductive connection section 70b or an electric potential of the solid electrolyte layer 62. Thus, electrolytic polymerization is carried out so as to form the conductive layer 64b and to obtain an intermediate 5b. The conductive layer 64b is formed on the solid electrolyte layer 62 and is also formed on the conductive connection section 70b. The intermediate 5b includes the capacitor element 10b and the conductive connection section 70b.

After the formation of the conductive layer 64b, as shown in FIG. 14, the intermediate 5b is soaked into the plating solution 82. In addition, a voltage is applied between the plating solution 82 and the supporter 100 so that an electric potential of the plating solution 82 is higher than another electric potential of the supporter 100, i.e. an electric potential of the conductive connection section 70b or an electric potential of the cathode layer 60b. Thus, the plated layer 80b is formed. Subsequently, the conductive connection section 70b is removed with a laser so that the cathode layer 60b and the anode lead wire 30 are electrically separated. At the same time, the plated layer 80b, the insulative section 50 and the additional dielectric layer 44 are also partially removed. Thus, the capacitor element 10b covered with the plated layer 80b is obtained.

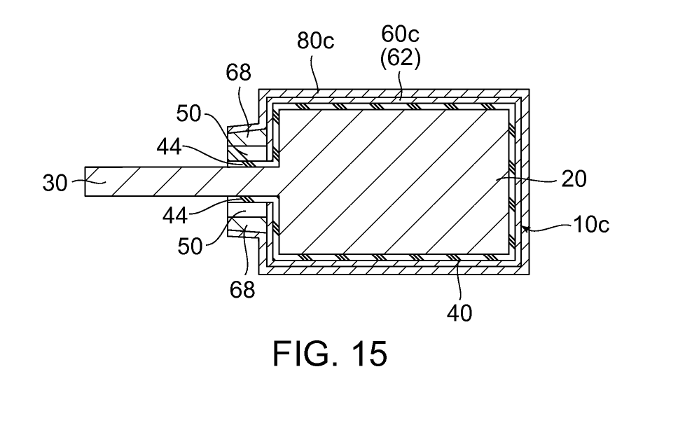

With reference to FIG. 15, a capacitor element 10c according to a fourth embodiment of the present invention is a modification of the capacitor element 10b of the above-mentioned third embodiment. In FIG. 15, components same as those of FIG. 11 are depicted with reference numerals same as those of the same components; explanation about those components will be omitted.

As understood from comparison of FIG. 11 with FIG. 15, a cathode layer 60c of the present embodiment is different from the cathode layer 60b of the fourth embodiment in that the cathode layer 60c does not include the conductive layer 64b of electrolytic polymerization layer. In this embodiment, when a conductive connection section 70c is formed, an intermediate 5c can be obtained. In addition, the plated layer 80c of the present embodiment is formed directly on the solid electrolyte layer 62.

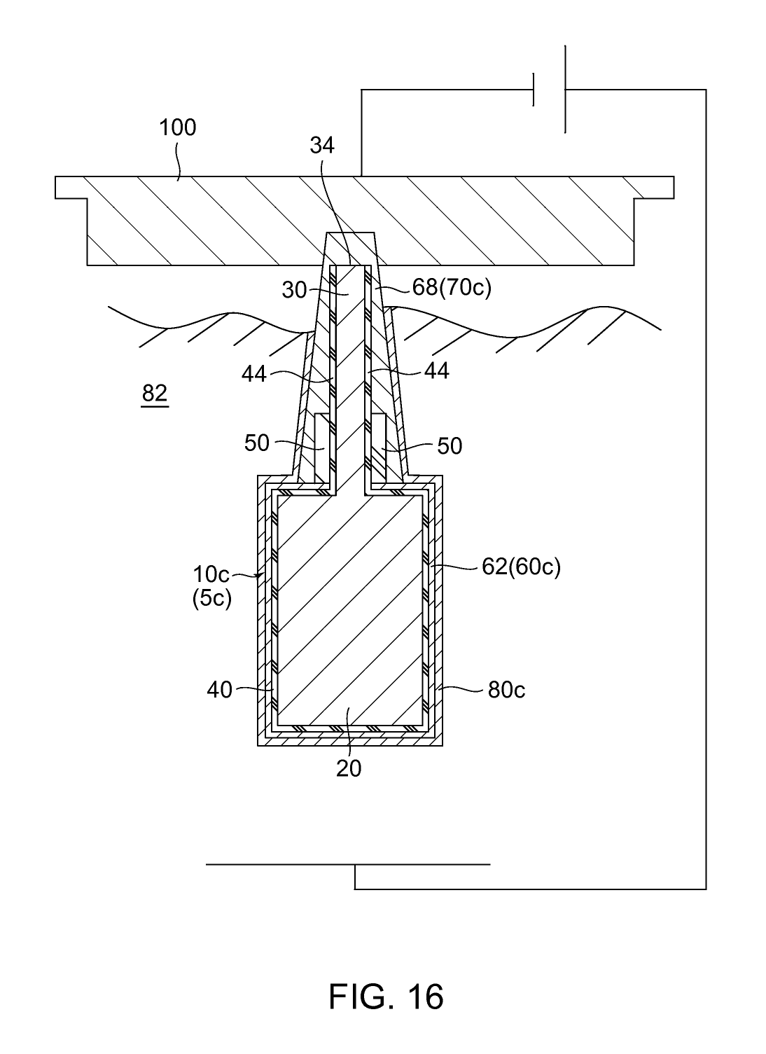

In detail, as shown in FIG. 16, after the formation of the conductive connection section 70c, the intermediate 5c is soaked into the plating solution 82 while an end of the conductive connection section 70c is supported by the supporter 100 made of aluminum. In addition, a voltage is applied between the plating solution 82 and the supporter 100 so that an electric potential of the plating solution 82 is higher than another electric potential of the supporter 100, i.e. an electric potential of the conductive connection section 70c or an electric potential of the cathode layer 60c. Thus, the plated layer 80c is formed. Subsequently, the conductive connection section 70c is removed with a laser so that the cathode layer 60c and the anode lead wire 30 are electrically separated. At the same time, the plated layer 80c, the insulative section 50 and the additional dielectric layer 44 are also partially removed. Thus, the capacitor element 10c covered with the plated layer 80c is obtained.

Since the plated layer 80, 80a, 80b, 80c is formed after the anode lead wire 30 and the cathode layer 60, 60a, 60b, 60c is connected with each other by using the conductive connection section 70, 70a, 70b, 70c in each of the above-described embodiment, no potential difference occurs between the anode body 20 and the cathode layer 60, 60a, 60b, 60c which sandwich the dielectric layer 40. Therefore, electrical currents do not flow into the dielectric layer 40 upon the formation of the plated layer 80, 80a, 80b, 80c so that the plated layer 80, 80a, 80b, 80c with high quality can be obtained. However, the present invention is not limited thereto. The plated layer 80, 80a, 80b, 80c may be formed on the cathode layer 60, 60a, 60b, 60c by using the rectification characteristic of the dielectric layer 40 based on its valve act, without using the conductive connection section 70, 70a, 70b, 70c.

The present application is based on a Japanese patent application of JP2013-250970 filed before the Japan Patent Office on Dec. 4, 2013, the contents of which are incorporated herein by reference.

While there has been described what is believed to be the preferred embodiment of the invention, those skilled in the art will recognize that other and further modifications may be made thereto without departing from the spirit of the invention, and it is intended to claim all such embodiments that fall within the true scope of the invention.

What is claimed is:

1. A method of forming a solid electrolytic capacitor comprising:
forming an intermediate which comprises a capacitor element, the capacitor element including an anode body, a dielectric layer formed on the anode body, a cathode layer formed on the dielectric layer and an anode lead wire extending from the anode body; and
forming a plated layer on the cathode layer by soaking the intermediate into a plating solution to apply a voltage between the plating solution and the anode lead wire so that an electric potential of the plating solution is higher than another electric potential of the anode lead wire.

2. The method of forming a solid electrolytic capacitor of claim 1, wherein:
the intermediate further comprises a conductive connection section which connects the cathode lead wire with the anode lead wire; and
the method further comprises removing the conductive connection section to electrically separate the cathode layer and the anode lead wire.

3. The method of forming a solid electrolytic capacitor of claim 2, wherein the forming the intermediate comprises:
embedding in part the anode lead wire into the anode body;
forming the dielectric layer on the anode body while forming an additional dielectric layer on the anode lead wire, the additional dielectric layer being made of dielectric same as the dielectric layer;
forming a solid electrolyte layer on the dielectric layer;
removing in part the additional dielectric layer to form an exposed portion of the anode lead wire; and
forming a conductive layer on the solid electrolyte layer and on the exposed portion to obtain the cathode layer and the conductive connection section, the cathode layer being formed of the solid electrolyte layer and a part of the conductive layer, the conductive connection section being formed of a remaining part of the conductive layer.

4. The method of forming a solid electrolytic capacitor of claim 3, wherein the forming the intermediate further comprises: forming an insulative section on a part of the additional dielectric layer, the conductive connection section extending over the additional dielectric layer.

5. The method of forming a solid electrolytic capacitor of claim 3, wherein the forming the conductive layer comprises: forming a conductive polymer of monomers as the conductive layer by soaking the solid electrolyte layer and the exposed portion of the anode lead wire into a solution of the monomers to apply a voltage between the solution of the monomers and the anode lead wire so that an electric potential of the solution of the monomers is lower than another electric potential of the anode lead wire.

6. The method of forming a solid electrolytic capacitor of claim 3, wherein the forming the conductive layer comprises: applying and drying a conductive paste from the solid electrolyte layer to the exposed portion of the anode lead wire to obtain a hardened conductive paste as the conductive layer.

7. The method of forming a solid electrolytic capacitor of claim 2, wherein the forming the intermediate comprises:
embedding in part the anode lead wire into the anode body;
forming the dielectric layer on the anode body while forming an additional dielectric layer on the anode lead wire, the additional dielectric layer being made of dielectric same as the dielectric layer;
forming a solid electrolyte layer on the dielectric layer;
forming a conductive section which connects an end of the anode lead wire to the solid electrolyte layer, the conductive connection section being formed of a part of the conductive section; and
forming a conductive polymer of monomers on the solid electrolyte layer by soaking the solid electrolyte layer and the conductive section into a solution of the monomers to apply a voltage between the solution of the monomers and the anode lead wire so that an electric potential of the solution of the monomers is lower than another electric potential of the conductive connection section, the cathode layer including the solid electrolyte layer and a part of the conductive polymer.

8. The method of forming a solid electrolytic capacitor of claim 7, wherein the forming the intermediate further comprises: forming an insulative section on a part of the additional dielectric layer, the conductive connection section extending over the additional dielectric layer.

9. The method of forming a solid electrolytic capacitor of claim 2, wherein the forming the intermediate comprises:
embedding in part the anode lead wire into the anode body;
forming the dielectric layer on the anode body while forming an additional dielectric layer on the anode lead wire, the additional dielectric layer being made of dielectric same as the dielectric layer;
forming a solid electrolyte layer on the dielectric layer; and
forming a conductive section which connects an end of the anode lead wire to the solid electrolyte layer, the cathode layer including the solid electrolyte layer, the conductive connection section being formed of a part of the conductive section.

10. The method of forming a solid electrolytic capacitor of claim 9, wherein the forming the intermediate further comprises: forming an insulative section on a part of the additional dielectric layer, the conductive connection section extending over the additional dielectric layer.
